(19) United States
(12) Patent Application Publication
(10) Pub. No.: US 2010/0328722 A1
(43) Pub. Date: Dec. 30, 2010

(54) IMAGE FORMING APPARATUS AND IMAGE FORMING METHOD

(76) Inventor: Yutaka YASUNAGA, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/825,794

(22) Filed: Jun. 29, 2010

(30) Foreign Application Priority Data
Jun. 30, 2009 (JP) 2009-155166

(51) Int. Cl. G06F 3/12

(52) U.S. Cl. 358/1.15

(57) ABSTRACT

Disclosed is an image forming apparatus to obtain image data and print information including a setting value to generate an added image synthesized to the image data and to form an image based on the obtained image data, the image forming apparatus including: a control section to generate the added image based on the setting value included in the print information and to synthesize the generated added image with the image data to form an image.

### BACKGROUND

1. Field of the Invention

The present invention relates to an image forming apparatus and an image forming method.

2. Description of Related Art

When double-sided printing (printing on both sides) or two-in-one printing (printing two original images on one sheet) is performed on the image forming apparatus, it is necessary to accurately align the image which is to be formed on the sheet. As a mark for alignment and cutting, a mark for alignment (hereinafter referred to as mark) is printed in a margin portion in an area other than the image on the sheet.

A printer controller of the image forming apparatus performs Raster Image Processing (RIP) to convert an image transmitted from a personal computer (PC), etc. to an image for printing. Here, image synthesizing processing to synthesize image data of a mark to image data is performed.

Japanese Patent Application Laid-Open Publication No. H11-216935 describes a technique of creating a mark based on size information, etc. of the print sheet associated with the print data and then synthesizes the mark to the image or document and prints the output without resulting in increase of data amount or complex processing.

Japanese Patent Application Laid-Open Publication No. 2007-272782 describes an information processing apparatus which can determine a position of the original data according to a method of imposition so as to be able to perform imposition processing of original data more efficiently.

Japanese Patent Application Laid-Open Publication No. 2007-272783 describes an information processing apparatus which can position the original data to be positioned in the center position to perform imposition processing of the original data more efficiently.

However, when the position where the mark is to be printed is changed after the images are synthesized, with the technique described in Japanese Patent Application Laid-Open Publication No. H11-216935, the image needs to be created in the printer controller again and resent to the printer. As for the technique described in Japanese Patent Application Laid-Open Publication No. 2007-272782 and Japanese Patent Application Laid-Open Publication No. 2007-272783, the imposition processing of the original data can be performed efficiently, however in order to change the position where the mark is to be printed, image processing needs to be performed in the printer controller in a similar manner.

When there is an instruction to insert a white page by user operation, since the sequence of the pages changes and the page on which the mark is to be printed changes, image processing on the printer controller needs to be performed again. Also, the memory on the printer side needs a memory area with a size including the mark data. Further, it is difficult for the printer controller to judge characteristics of the device of the printer side which makes it difficult for the printer controller to determine the mark position reflecting such characteristics. Also, in the copying function, the printer controller is not used, and thus the mark could not be printed.

### SUMMARY

The present invention has been made in consideration of the above problems, and it is one of main objects to print a mark without using a printer controller.

In order to achieve at least one of the above-described objects, according to an aspect of the present invention, there is provided an image forming apparatus to obtain image data and print information including a setting value to generate an added image synthesized to the image data and to form an image based on the obtained image data, the image forming apparatus including:
a control section to generate the added image based on the setting value included in the print information and to synthesize the generated added image with the image data to form an image.

According to another aspect of the present invention, there is provided an image forming method of an image forming apparatus to obtain image data and print information including a setting value to generate an added image to synthesize with the image data, the method including:
controlling to generate the added image based on the setting value included in the print information, to synthesize the generated added image with the image data to perform image forming.

### BRIEF DESCRIPTION OF THE DRAWINGS

The present invention will become more fully understood from the detailed description given hereinbelow and the appended drawings, and thus are not intended to define the limits of the present invention, and wherein;

FIG. 1 is a system configuration diagram showing an image forming system of the present embodiment;

FIG. 2 is a block diagram showing an image forming apparatus shown in FIG. 1;

FIG. 3 is a diagram showing a flow of processing of the image forming system of the present embodiment;

FIG. 4 is a flowchart showing an operation of image output performed by the image forming apparatus;

FIG. 5 is a flowchart showing imposition processing performed by the image forming apparatus;

FIG. 6 is a schematic diagram showing a paper divided in two with respect to the long edge;

FIG. 7 is a flowchart showing a mark position calculation processing performed by the image forming apparatus;

FIG. 8 is a flowchart showing a crop mark position calculation processing performed in the image forming apparatus;

FIG. 9 is an enlarged diagram showing a crop mark printed at the upper left of the image;

FIG. 10A is a schematic diagram showing a position of the crop mark drawn when the imposition is one face;

FIG. 10B is a schematic diagram showing a position of the crop mark drawn when the imposition is two faces and the method of drawing the crop mark is drawing with respect to each sheet;

FIG. 10C is a schematic diagram showing a position of the crop mark drawn when the imposition is two faces and the method of drawing the crop mark is drawing with respect to each page;

FIGS. 11A and 11B are flowcharts showing crop mark image penetration checking processing performed by the image forming apparatus;

FIG. 12 is a flowchart showing a register mark position calculation processing performed by the image forming apparatus;

FIG. 13 is an enlarged diagram of a register mark printed at the center of the image;

FIG. 14 is an explanatory diagram to explain in detail the image output processing performed by the image forming apparatus;

FIG. 15 is a schematic diagram showing the sheet on which the image is printed when the image printed on the last page is only one face when a plurality of images are imposed;

FIG. 16 is an explanatory diagram to explain when the crop mark offset information is reflected and the coordinates where the crop mark is applied is calculated;

FIG. 17 is a diagram showing an example of a shape of the mark which can be selected in the third embodiment;

FIG. 18A is a diagram showing an example of a sheet when an area which is maximum among all pages is the result of the mark drawing position calculation in one-in-one printing;

FIG. 18B is a diagram showing an example of a sheet when an area which is maximum among all pages is the result of the mark drawing position calculation in two-in-one printing;

FIG. 19 is a schematic diagram showing a sheet when the color used in printing is changed according to the position of the crop mark;

FIG. 20 is a block diagram showing the control system of the image forming apparatus of the seventh embodiment;

FIG. 21A is a schematic diagram showing an image formed on the sheet when the magnification of the front and back is not set; and

FIG. 21B is a schematic diagram showing when the mark drawing position is calculated in accordance with the maximum value of the area of the entire image on the front and back.

### DETAILED DESCRIPTION OF PREFERRED EMBODIMENTS

A preferred embodiment reflecting an aspect of the present invention is described in detail with reference to the drawings. However, the scope of the invention is not limited to the illustrated examples.

### First Embodiment

The configuration of the image forming apparatus 1 of the present embodiment is described.

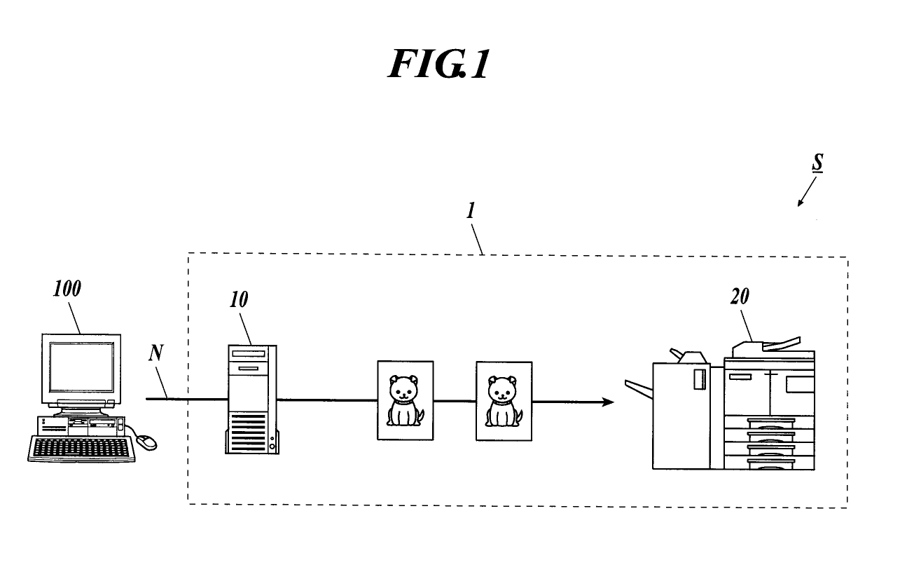

FIG. 1 shows a schematic diagram of an image forming system S configured from a PC 100 and an image forming apparatus 1. As shown in FIG. 1, the PC 100 and the image forming apparatus 1 are connected so as to be able to transmit and receive data through the network N.

By user operation, the PC 100 inputs various pieces of information necessary for forming an image to the image forming apparatus 1. For example, the information includes image data of the image formed on the sheet, a size of the image, an image pasting position to show where the image is formed (hereinafter, the image data, the size and the image pasting position are collectively referred to as image information), size information of a sheet on which the image is formed, imposition information to identify content of imposition, various information concerning the mark to be printed on the sheet (hereinafter, simply referred to as mark information), etc.

Imposition is the number of pieces of image data which is to be formed on the sheet. The image forming apparatus 1 indentifies the number of pieces of image data to be formed on the sheet with the imposition information, and performs, for example two-in-one printing (imposition of two planes), one-in-one printing (imposition of one plane), etc. Any number can be selected arbitrarily as the number of pieces of image data to be imposed, and in the present embodiment, two-in-one printing is described.

The mark information input on the PC 100 includes trimming margin, crop mark presence information showing whether or not a crop mark to show trimming position is present or not, crop mark drawing method to show whether to print the crop mark and the register mark with respect to each page or with respect to each sheet, mark output page setting to show whether to print the mark on all pages or only the first page (front page), and register mark presence information to show whether or not there is a register mark to show center position of the image or sheet.

The image forming apparatus 1 is mainly comprised of a printer controller 10 and a printer engine 20. The printer controller 10 performs various processing such as RIP processing to convert image data based on the print data received from the PC 100 so as to allow the printer engine 20 to perform the image forming. The control by the printer controller 10 allows the image forming apparatus 1 to function as a network printer.

The printer engine 20 is the main body of the image forming apparatus 1 to form the image on the sheet based on the image data input from the PC 100 through the printer controller 10.

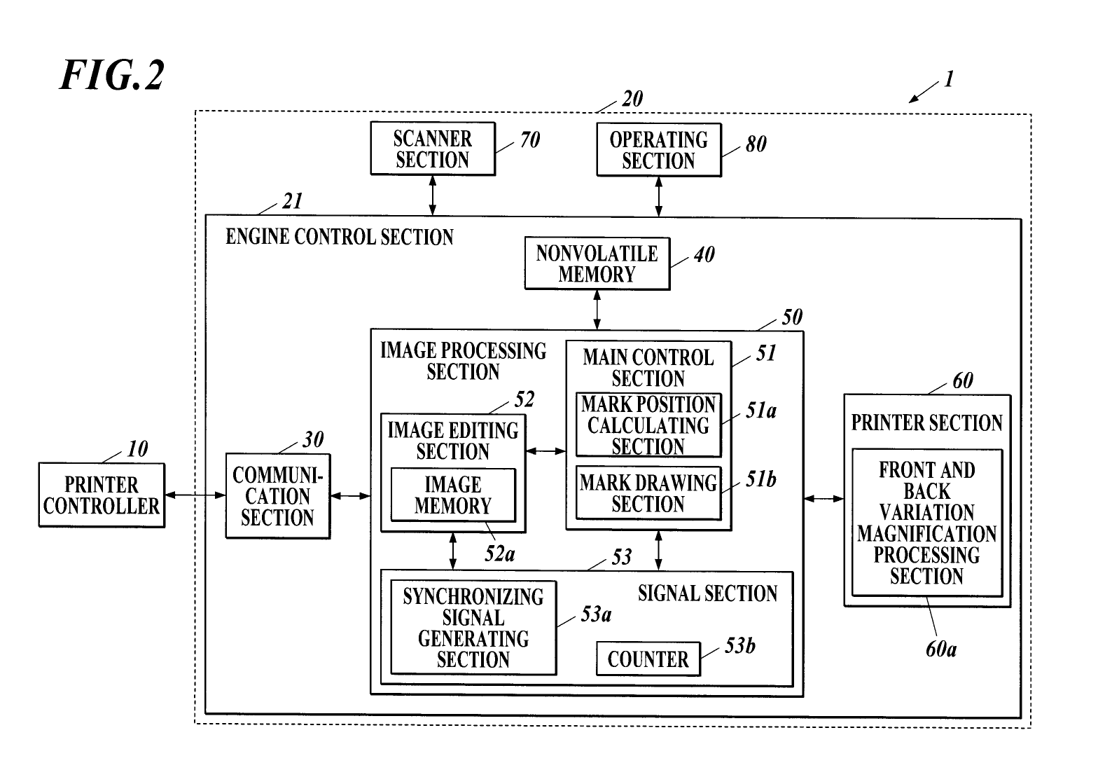

FIG. 2 shows a block diagram of the control system of the image forming apparatus 1.

As shown in FIG. 2, the image forming apparatus 1 includes the printer controller 10, the printer engine 20, an engine control section 21, a scanner section 70, an operating section 80, etc.

The engine control section 21 centrally controls an internal section of the image forming apparatus 1 and includes a communication section 30, a nonvolatile memory 40, an image processing section 50, a printer section 60 and the like.

The communication section 30 is a communication interface to connect to a network with the PC 100 through the printer controller 10 with a LAN, a modem, NIC (Network Interface Card), and the like.

The nonvolatile memory 40 includes an HDD or a ROM which is to be a program memory and stores various processing programs, data, etc. concerning image forming. Also, the nonvolatile memory 40 stores data concerning image information, mark information, imposition information, sheet size, later-described various setting values necessary when an image is output, and various conditions to perform the jobs, which are input from the PC 100.

The image processing section 50 includes a main control section 51, image editing section 52, signal section 53, etc. and performs various processing on the image to be formed on the sheet.

The main control section 51 includes a CPU (Central Processing Unit), RAM (Random Access Memory), etc., and centrally controls each section of the engine control section 21. In conjunction with the program stored in the nonvolatile memory 40, the main control section 51 performs the later described image output operation to function as the mark position calculating section 51a and the mark drawing section 51b.

The image editing section 52 includes an image memory 52a, etc. and performs various image processing such as compression and decompression on the image data input from the PC 100 through the printer controller 10 according to control by the main control section 51. The image memory 52a includes an HDD, etc. and stores image data input from the PC 100 and the scanner section 70.

The signal section 53 includes a synchronizing signal generating section 53a to generate a signal necessary when the image is formed in the printer section 60, a counter 53b, etc.

The printer section 60 performs image forming processing with an electro-photographic method based on the input image data. The printer section 60 includes a sheet feeding tray to store sheets on which the image is formed, a conveying roller to convey the sheet to the sheet feeding tray, the ejecting section to eject the sheet on which the image is formed, an image forming section including a photoconductive drum, compression roller, etc. to form an image on the sheet (all not shown). The printer section 60 includes a front and back variation magnification processing section 60a to perform variation magnification processing on the image data after RIP processing based on control by the main control section 51.

The scanner section 70 reads an image of the document sent by the ADF (Auto Document Feeder). The document placed on a document tray of the scanner section 70 is conveyed onto the contact glass which is the position where the document is read and an image of one face or two faces on the document is scanned by the optics system and the image of the document is read by the CCD (Charge Coupled Device) to obtain the image data.

The operating section 80 includes an LCD (Liquid Crystal Display), a touch panel provided so as to cover the LCD, operation keys and the like. The operating section 80 receives an instruction from the user and outputs the operation signal to the engine control section 21. The operating section 80 displays the various operating instructions, various setting screens to input setting information, various processing results, etc. based on the display signal input from the engine control section 21.

Next, the operation of the image forming system S is described.

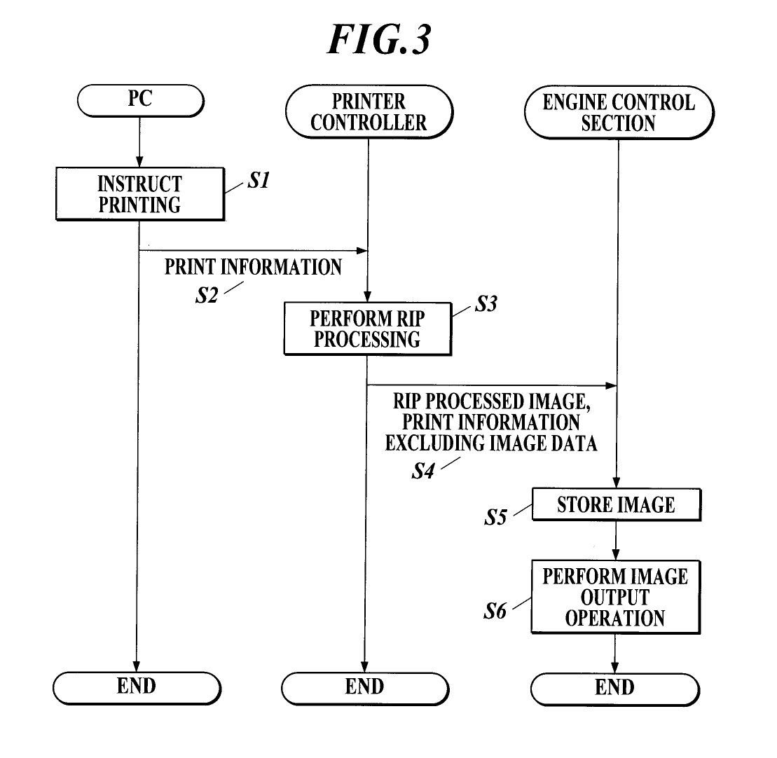

FIG. 3 shows a flow of the processing of the image forming system S of the present embodiment.

First, as shown in FIG. 3, a print instruction, etc. is input on the PC 100 (step S1). The print instruction is instructed by user input through a mouse, etc. of the PC 100 and is input with the image information, the imposition information, the sheet size information, the mark information, etc. (hereinafter collectively referred to as print information). For example, image information includes information showing the image data is five sheets and the size of the image data is the size of A5 (148.5 mm×210 mm) and a value indicating the position where the image is formed is the center. Information representing an output instruction to print in two-in-one mode is transmitted as imposition information. A value indicating the document size of the sheet on which the image is formed is A3 (420 mm×297 mm) is transmitted as the sheet size information. The value indicating crop mark is present, margin of trimming is 3 mm, printing of crop mark is performed with respect to each page, register mark is present and mark is printed on all pages is transmitted as mark information.

Next, the print instruction and the print information are transmitted through the network N to the printer controller 10 (step S2). RIP processing is performed in the printer controller 10 (step S3). The RIP processing is image conversion processing to convert image data received from the PC 100 to image data (Video data) which can be output from the printer section 60 when image forming is performed based on the image data received from the PC 100. Various known methods can be used as the RIP processing.

One or a plurality of pieces of image data generated by the RIP processing (hereinafter referred to as RIP processed image data) and print information (excluding image data) input from the PC 100 are transmitted to the engine control section 21 (step S4). Specifically, when a plurality of pieces of image data are included in the image information input from the PC 100, each piece of the RIP processed image data generated by RIP processing is transmitted through the communication section 30 of the engine control section 21 to the image processing section 50. The print information (imposition information, etc.) other than the image data is transmitted from the printer controller 10 to the engine control section 21 after the transmission of all pieces of the image data is finished. The print information can be transmitted from the printer controller 10 to the engine control section 21 at an arbitrary timing, for example, transmission with respect to each page, or transmission before the transmission of image data starts.

The engine control section 21 stores the RIP processed image data received from the printer controller 10 in the image memory 52a (step S5). The received print information (excluding the image data) is temporarily stored in the RAM (not shown) or the like.

Next, the RIP processed image data stored in the image memory 52a is read out and image output operation to perform image forming by adding a mark on the RIP processed data is executed to form an image in the printer section 60 (step S6).

Below, the image output operation performed in step S6 is described in detail.

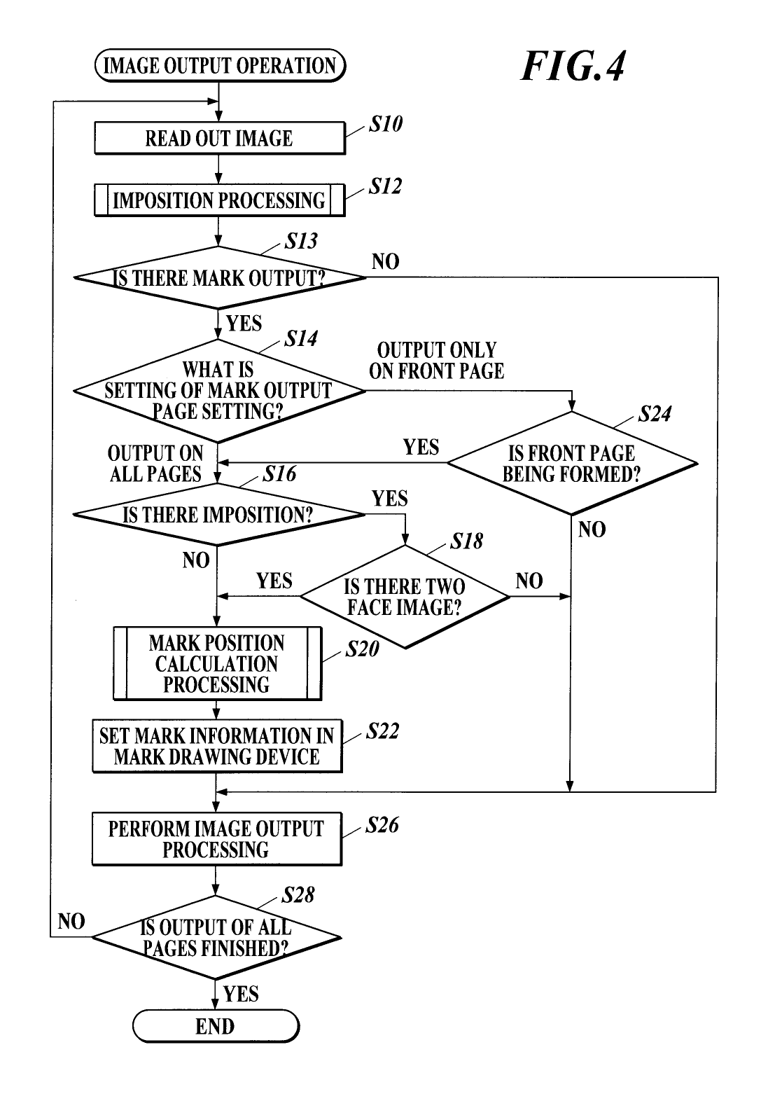

FIG. 4 shows a flowchart of the image output operation. When the image forming starts according to a print instruction, the main control section 51 performs the image output operation in conjunction with the program stored in the nonvolatile memory 40. In the image output operation, an added image (crop mark and register mark) is synthesized to the RIP processed image data stored in the image memory 52a based on the print information received from the PC 100 through the printer controller 10.

First, as shown in FIG. 4, the RIP processed image data stored in the image memory 52a is read out (step S10). Then, the imposition processing is performed (step S12).

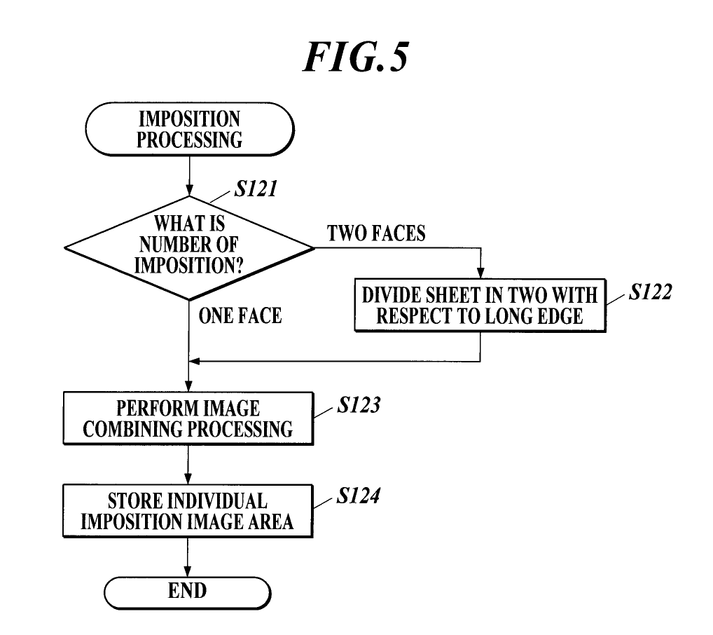

FIG. 5 shows a flowchart showing an imposition processing performed in step S11.

First, as shown in FIG. 5, the number of imposition is determined based on the imposition information received through the printer controller 10 (step S121). When it is determined that the number of imposition is two faces (step S121; two faces), the area is divided in two with respect to the long edge of the sheet (step S122). Specifically, two dimensional coordinates included in the area corresponding to the sheet with respect to each size of the sheet are stored in the nonvolatile memory 40 and the size of the sheet is determined based on the sheet information received through the printer controller 10 and the coordinates are divided in two.

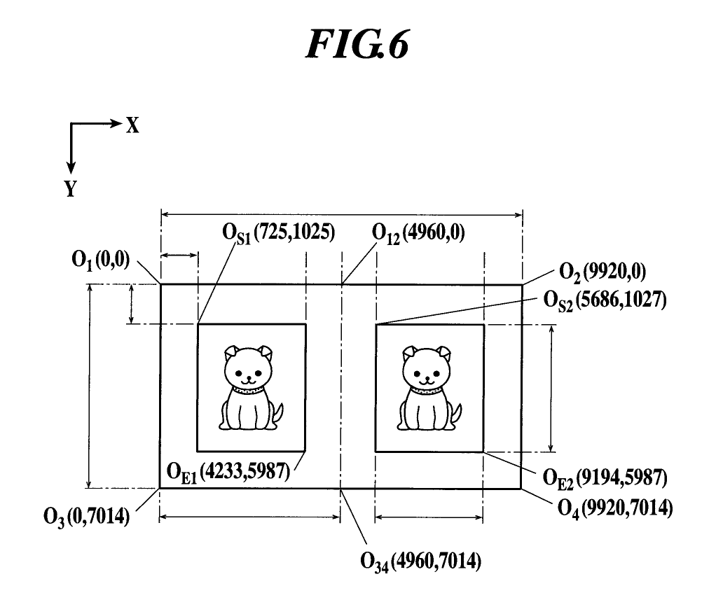

FIG. 6 is a schematic diagram showing a sheet divided in two with respect to the long edge in step S122. FIG. 6 is an example showing when a size A3 sheet is divided in two. When the long edge is placed in the top and bottom, the upper left edge of the sheet is to be coordinate O₁, the upper right edge of the sheet is to be coordinate O₂, the lower left edge of the sheet is to be coordinate O₃, and the lower right edge of the sheet is to be coordinate O₄. The four edges of the sheet with the coordinate O₁ to coordinate O₄ are stored in the nonvolatile memory 40 corresponding to the size of the sheet. For example, when the size of the sheet is A3, the coordinate O₁ is stored as (0, 0), the coordinate O₂ is stored as (9920, 0), the coordinate O₃ is stored as (0, 7014) and the coordinate O₄ is stored as (9920, 7014). Hereinafter, one unit of the coordinates is referred to as a dot.

In the example shown in FIG. 6, the long edge of the sheet is the line connecting the coordinate O₁ and the coordinate O₂, and the line connecting the coordinate O₃ and the coordinate O₄. The long edge can be judged by comparing the length of the line connecting the coordinate O₁ and the coordinate O₂ and the line connecting the coordinate O₁ and the coordinate O₃ or information to identify the coordinate corresponding to the long edge can be stored in advance in the nonvolatile memory 40. When the long edge of the sheet is divided in two, the sheet is divided in two by a line connecting the middle points (each referred to as coordinate O₁₂ and coordinate O₃₄) of the two long edges. In the above described coordinate example, the coordinate O₁₂ is (4960, 0) and the coordinate O₃₄ is (4960, 7014).

Next, image combining processing is performed (step S123). The image combining processing is processing to determine the position where the image is formed on the sheet and is determined by calculating the position of the image based on the image information and the imposition information. For example, when images with a size of A5 are printed with two-in-one printing centered (center alignment) on the A3 sheet, with the coordinate example shown in FIG. 6, images are formed in rectangular areas where the left face of the two-in-one printing is a rectangular area with a diagonal line connecting coordinate Oₛ₁ (725, 1025) and coordinate O_{E1} (4233, 5987) and the right face of the two-in-one printing is a rectangular area with a diagonal line connecting coordinate Oₛ₂ (5686, 1027) and coordinate O_{E2} (9194, 5987). In step S123, the two areas are calculated. When the imposition is one face, one area is calculated and when the imposition is two faces, two areas are calculated. The areas in which the images are formed represented by such diagonal lines are referred to as the individual imposition image area.

When the image combining processing is performed, the individual imposition image area calculated as described above is stored in the RAM of the main control section 51 (step S124). In step S124, the coordinate composing the diagonal lines showing the individual imposition image area is stored in the RAM of the main control section 51.

Returning to FIG. 4, it is judged whether or not there is a mark output setting based on the mark information received from the printer controller 10 (step S13). When it is judged there is a mark output setting (step S13; YES) the mark output page setting is judged (step S14). When it is judged there is no mark output setting (step S13; NO), the processing advances to a later described step S26.

When it is judged that mark output page setting shows output on all pages (step S14; output on all pages), it is judged whether or not there is a setting of imposition (step S16). When it is judged there is a setting of imposition (step S16; YES), it is judged whether or not there is a two face image (showing two images are formed on the sheet) on the sheet to form the image (step S18). When the imposition is set to the two face image, but only one image is formed on the last page, it is judged in step S18 that there is no two face image.

When it is judged there is a setting of imposition (step S16; NO), and it is judged there is the two face image (step S18; YES), the mark position calculation processing is performed (step S20).

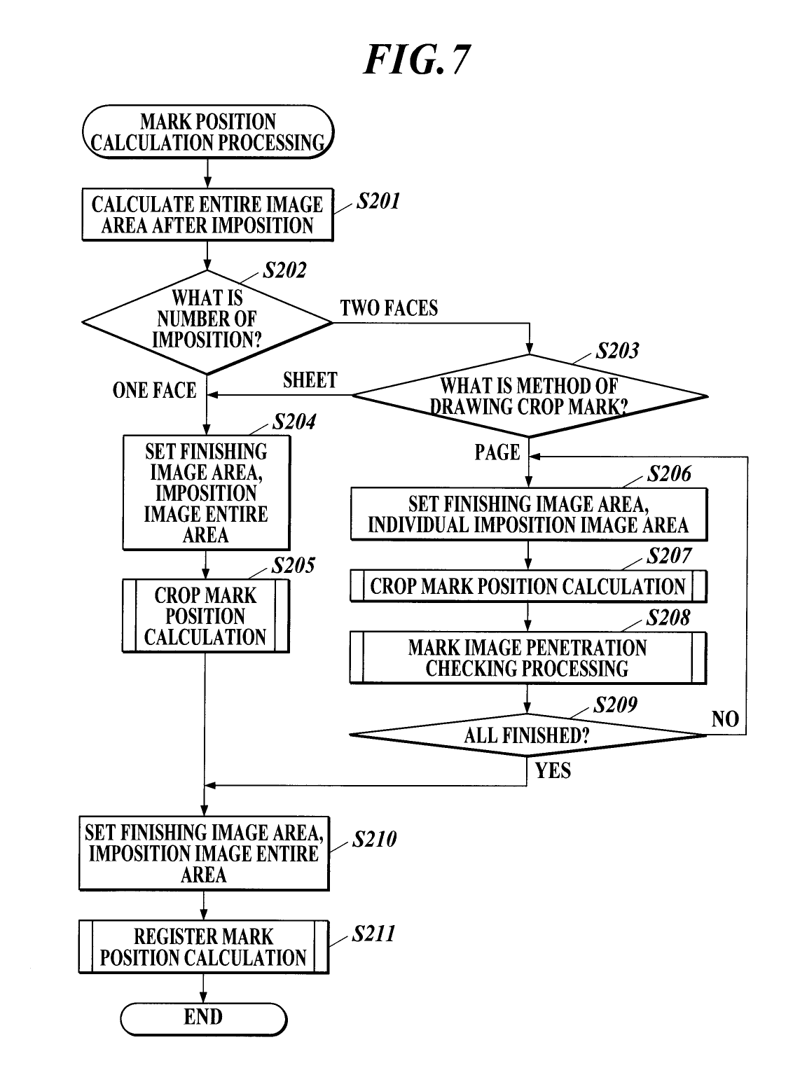

FIG. 7 is a flowchart showing a mark position calculation processing performed in step S20. By performing the mark position calculation processing, the main control section 51 functions as the mark position calculating section 51a.

First, as shown in FIG. 7, the entire image area after imposition (hereinafter referred to as imposition image entire area) is calculated (step S201). The imposition image entire area is the maximum area of the image area positioned on one sheet and in the example shown in FIG. 6, the area surrounded by a rectangle with a diagonal line connecting the coordinate O_{S1} and coordinate O_{E2}. When the imposition is one face, the entire image area and the individual imposition image area match. In step S201, these coordinates are stored in the RAM of the main control section 51.

The number of imposition is determined based on the imposition information received from the printer controller 10 (step S202). When it is judged the number of imposition is two faces (step S202; two faces) the drawing method of the crop mark is judged based on the mark information received from the printer controller 10 (step S203).

When it is judged the number of imposition is one face (step S202; one face), and the drawing method of the crop mark is with respect to each sheet (step S203; sheet), the imposition image entire area calculated in step S201 is set as the finishing image area and is stored in the RAM of the main control section 51 (step S204). The finishing image area is an area showing a unit of an image on which the crop mark or register mark is applied. Next, the crop mark position calculation processing (described in detail later) is performed (step S205). When the drawing method of the crop mark is with respect to each page (step S203; page), the individual imposition image area is set as the finishing image area and stored in the RAM of the main control section 51 (step S206). Next, the crop mark position calculation processing is performed (step S207).

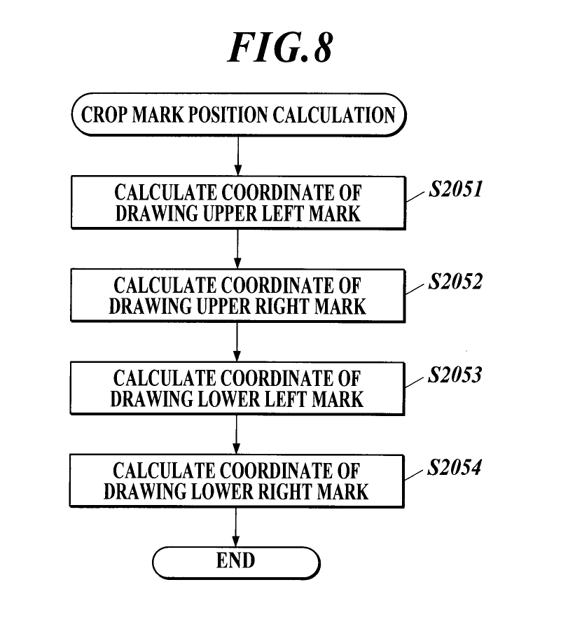

FIG. 8 shows a flowchart of the crop mark position calculation processing performed in step S205 and step S207. First, as shown in FIG. 8, the coordinate of the crop mark drawn in the position corresponding to the upper left of the image (coordinate O_{S1} of the example shown in FIG. 6) is calculated (step S2051).

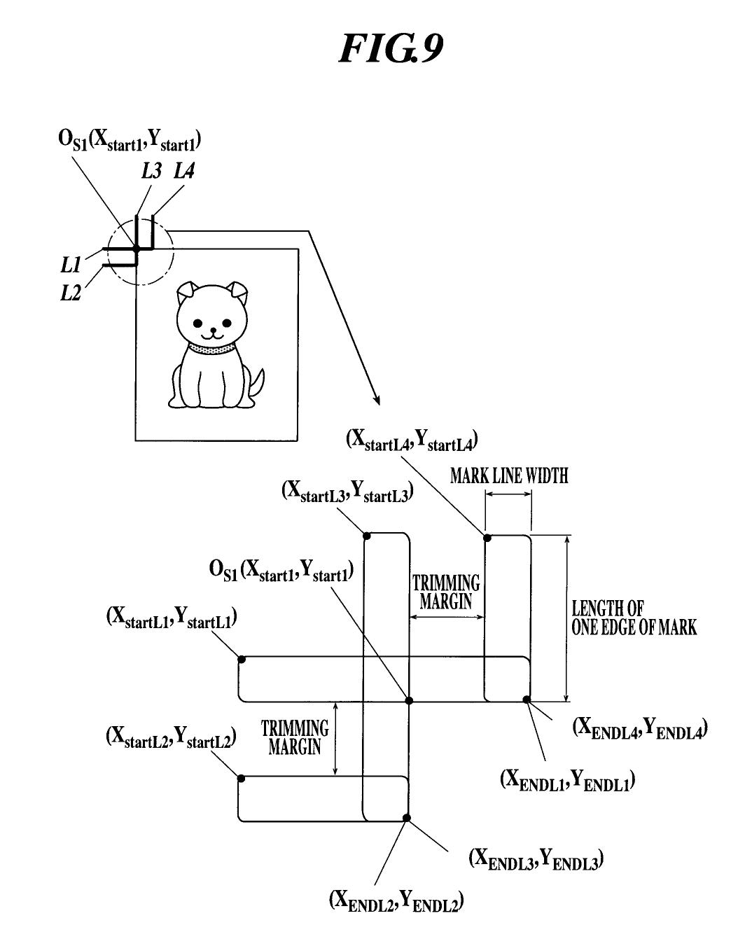

FIG. 9 shows an enlarged diagram of a crop mark printed in the upper left of the image. The crop mark of the present embodiment is composed of four lines of lines L1 to L4.

When the coordinate of the upper left of the image is O_{S1} (X_{Start1}, Y_{Start1}), line L1 is a rectangular area with a diagonal line connecting (X_{StartL1}, Y_{StartL1})=(X_{Start1}−length of one edge of mark, Y_{Start1}−mark line width) and (X_{ENDL1}, Y_{ENDL1})=(X_{Start1}+trimming margin+mark line width, Y_{Start1}). The length of one edge of mark is a value showing a length of the mark. The mark line width is a value showing the width of the lines L1 to L4 (for example, 4dot: four coordinates). The length of one edge of mark and the mark line width are both stored in the nonvolatile memory 40 and the value can be changed by input from the operating section 80.

The line L2 is a rectangular area with a diagonal line connecting (X_{StartL2}, Y_{StartL2})=(X_{Start1}−length of one edge of mark, Y_{Start1}+trimming margin) and (X_{ENDL2}, Y_{ENDL2})=(X_{Start1}, Y_{Start1}+trimming margin+mark line width).

The line L3 is a rectangular area with a diagonal line connecting (X_{StartL3}, Y_{StartL3})=(X_{Start1}−mark line width, Y_{Start1}−length of one edge of mark) and (X_{ENDL3}, Y_{ENDL3})=(X_{Start1}, Y_{Start1}+trimming margin+mark line width).

The line L4 is a rectangular area with a diagonal line connecting (X_{StartL4}, Y_{StartL4})=(X_{Start1}+trimming margin, Y_{Start1}−length of one edge of mark) and (X_{ENDL4}, Y_{ENDL4})=(X_{Start1}+trimming margin+mark line width, Y_{Start1}).

The coordinate of the crop mark drawn in the upper right of the image is calculated (step S2052). The coordinate of the crop mark drawn in the lower left of the image is calculated (step S2053). The coordinate of the crop mark drawn in the lower right of the image is calculated (step S2054). The processing in steps S2052 to S2054 are calculated similar to step S2051 based on the coordinates composing the finishing image area, length of one edge of mark, mark line width, and trimming margin and therefore the description is omitted. The coordinate corresponding to 16 lines which is the sum of the lines of the four crop marks is stored in the alignment, etc. and stored in the RAM of the main control section 51.

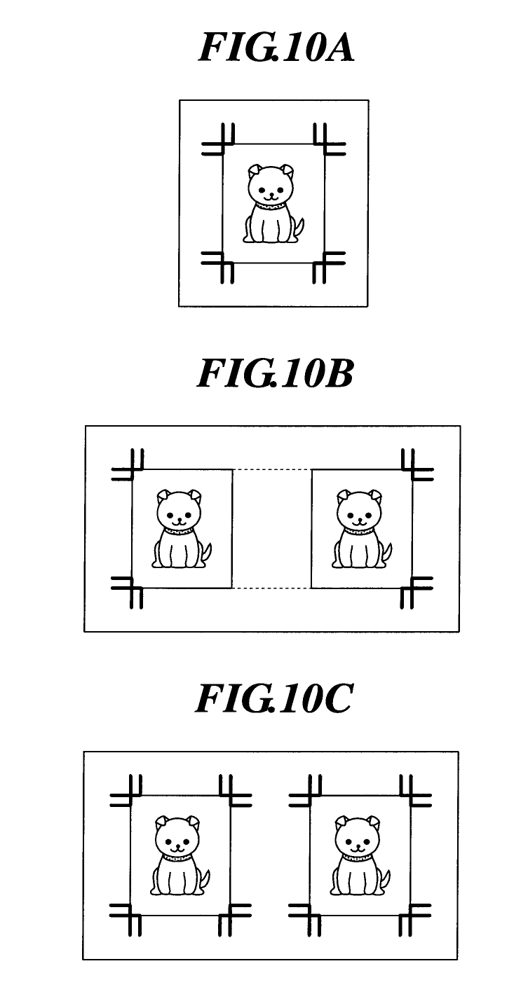

FIG. 10A to FIG. 10C schematically show the position of the crop mark calculated in the crop mark position calculation processing. FIG. 10A is a crop mark drawn when the imposition is one face and the crop mark is added to the four corners of the image. FIG. 10B is imposition of two faces and is a crop mark drawn when the crop mark drawing method is with respect to each sheet, and the crop mark is added to the four corners with two images as one unit. FIG. 10C is imposition with two faces and is a crop mark drawn when the crop mark drawing method is with respect to each page, and the crop mark is added to the four corners with each of the two images as a unit for drawing the mark.

Returning to FIG. 7, the crop mark image penetration checking processing is performed to determine whether or not the crop mark added to one image penetrates the other image area (step S208).

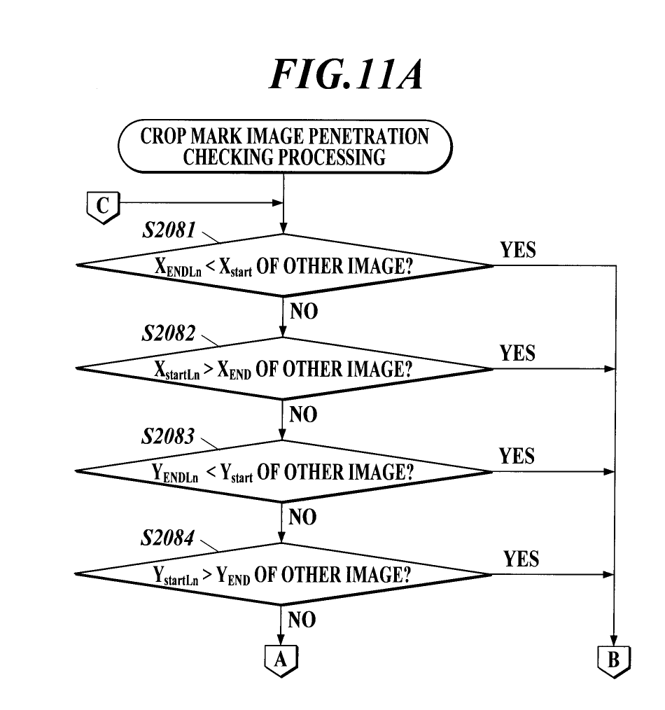

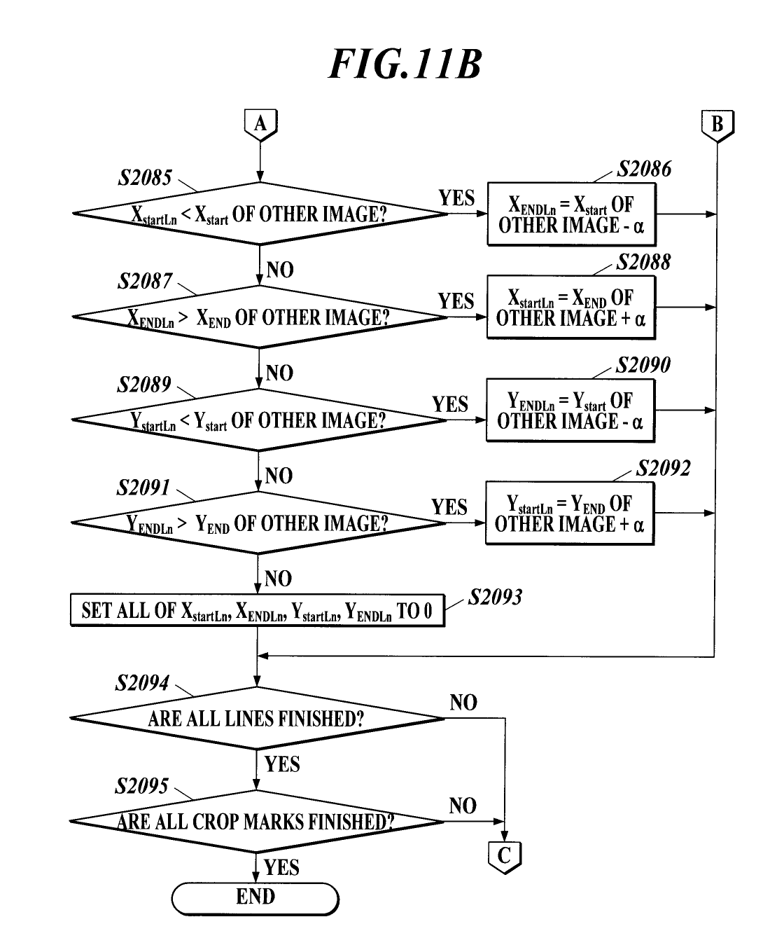

FIG. 11A and FIG. 11B show a flowchart of crop mark image penetration checking processing performed in step S208. As shown in FIG. 11A and FIG. 11B, it is judged whether or not the X_{ENDLn} of line Ln (hereinafter, “n” of Ln is an integer from 1 to 4) of the crop mark in one image is smaller than the Xₛₜₐᵣₜ (showing all of X_{StartL1} to X_{StartL4} are compared) of the other image formed on the same sheet (step S2081).

When it is judged that it is not smaller (step S2081; NO), it is judged whether or not the X_{StartLn} of the line the same as the line compared in step S2081 (hereinafter referred to as simple the same line) is larger than the X_{END} (showing all of X_{ENDL1} to X_{ENDL4} are compared) of the other image formed on the same sheet (step S2082).

When it is judged that it is not larger (Step S2082; NO) it is judged whether or not the Y_{ENDLn} of the same line is smaller than Y_{Start} (showing all of Y_{StartL1} to Y_{StartL4} are compared) of the other image formed on the same sheet (step S2083).

When it is judged that it is not smaller (step S2083; NO), it is judged whether or not the Yₛₜₐᵣₜ of the same line is larger than the Y_{END} (showing all of Y_{ENDL1} to Y_{ENDL4} are compared) of the other image formed on the same sheet (step S2084).

When it is judged that it is not larger (step S2084; NO), it is judged whether or not the X_{StartLn} of the same line is smaller than the X_{Start} of the other image formed on the same sheet (step S2085).

When it is judged that it is smaller (step S2085; YES), a numeric value where a predetermined constant a (for example, 1) is subtracted from X_{Start} of the other image when it is judged that it is smaller is substituted in the X_{ENDLn} of the same line (step S2086). In this case, it is judged that the right edge of the line penetrates the other image.

When it is judged that it is not smaller (step S2085; NO), it is judged whether or not the X_{ENDLn} of the same line is larger than the X_{END} of the other image formed on the same sheet (step S2087).

When it is judged that it is larger (step S2087; YES), a numeric value where a predetermined constant α is added to X_{END} of the other image when it is judged that it is larger is substituted in the X_{StartLn} of the same line (step S2088). In this case, it is judged that the left edge of the line penetrates the other image.

When it is judged that it is not larger (step S2087; NO), it is judged whether or not the Y_{StartLn} of the same line is smaller than the Y_{Start} of the other image formed on the same sheet (step S2089).

When it is judged that it is smaller (step S2089; YES), a numeric value where a predetermined constant α is subtracted from Y_{Start} of the other image when it is judged that it is smaller is substituted in the Y_{ENDLn} of the same line (step S2088). In this case, it is judged that the bottom edge of the line penetrates the other image.

When it is judged that it is not smaller (step S2089; NO), it is judged whether or not the Y_{ENDLn} of the same line is larger than the Y_{END} of the other image formed on the same sheet (step S2091).

When it is judged that it is larger (step S2091; YES), a numeric value where a predetermined constant α is added to Y_{END} of the other image when it is judged that it is larger is substituted in the Y_{StartLn} of the same line (step S2092). In this case, it is judged that the top edge of the line penetrates the other image.

When it is judged that it is not larger (step S2091; NO), it is judged that the entire area of the line penetrates the other image and 0 is substituted in all of X_{startLn}, X_{ENDLn}, Y_{StartLn}, and Y_{ENDLn} (Step S2093).

When it is judged that it is smaller (step S2081; YES), this shows that the line does not penetrate the other image and that the line is to the left side of the image area of the other image and the processing advances to step S2094.

When it is judged that it is larger (step S2082; YES), this shows that the line does not penetrate the other image and that the line is to the right side of the image area of the other image and the processing advances to step S2094.

When it is judged that it is smaller (step S2083; YES), this shows that the line does not penetrate the other image and that the line is to the upper side of the image area of the other image and the processing advances to step S2094.

When it is judged that it is larger (step S2084; YES), this shows that the line does not penetrate the other image and that the line is to the lower side of the image area of the other image and the processing advances to step S2094.

Then it is judged whether or not the checking of all of the lines Ln of the crop mark is finished (step S2094).

When it is judged that the checking is not finished (step S2094; NO), the processing returns to step S2081 and the checking of the next line is performed. In other words, one is incremented to n and for example, after checking line L1, checking of line L2 is performed.

When it is judged that the checking is finished (step S2094; YES), it is judged whether or not the checking of all of the crop marks of the image is finished (step S2095).

When it is judged that the checking is not finished (step S2095; NO), the processing returns to step S2081, and the checking of the line Ln of the crop mark which is not checked by the processing is performed. When it is judged that the checking is finished (step S2095; YES) the mark image penetration checking processing is finished.

Returning to FIG. 7, it is judged whether or not the drawing of all crop marks on all imposed images is finished (step S209). When it is judged that all is not finished (step S209; NO), the processing returns to step S206, and the position calculation of the crop mark of the next image (in other words, the other image formed on the same sheet) is performed.

When it is judged that it is all finished (step S209; YES), the imposition image entire area is set as the finishing image area and is stored in the RAM of the main control section 51 (step S210). Next, the processing of register mark position calculation is performed (step S211).

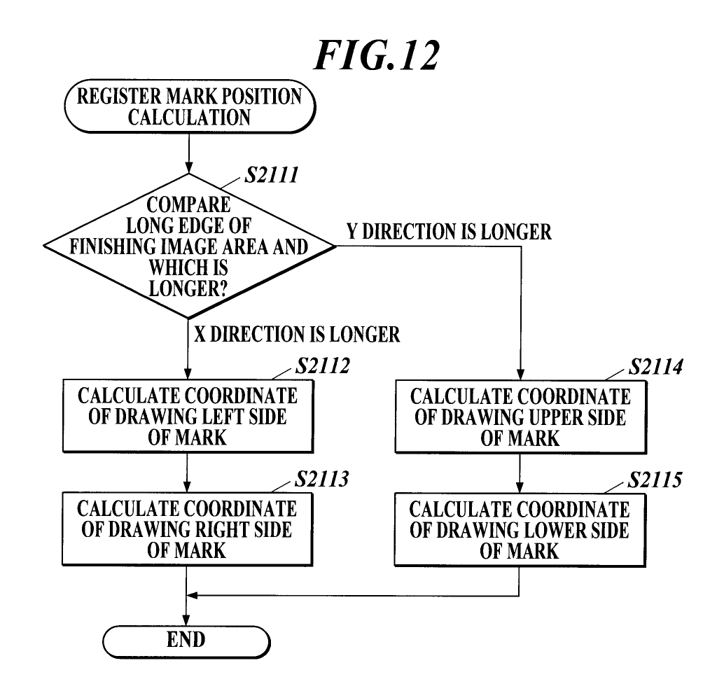

FIG. 12 is a flowchart showing a register mark position calculation processing performed in step S211. As shown in FIG. 12, first, the edge of the finishing image area is compared (step S2111).

When it is judged that it is longer in the X direction (step S2111; long in the X direction), the drawing coordinate of the left side of the register mark is calculated (step S2112).

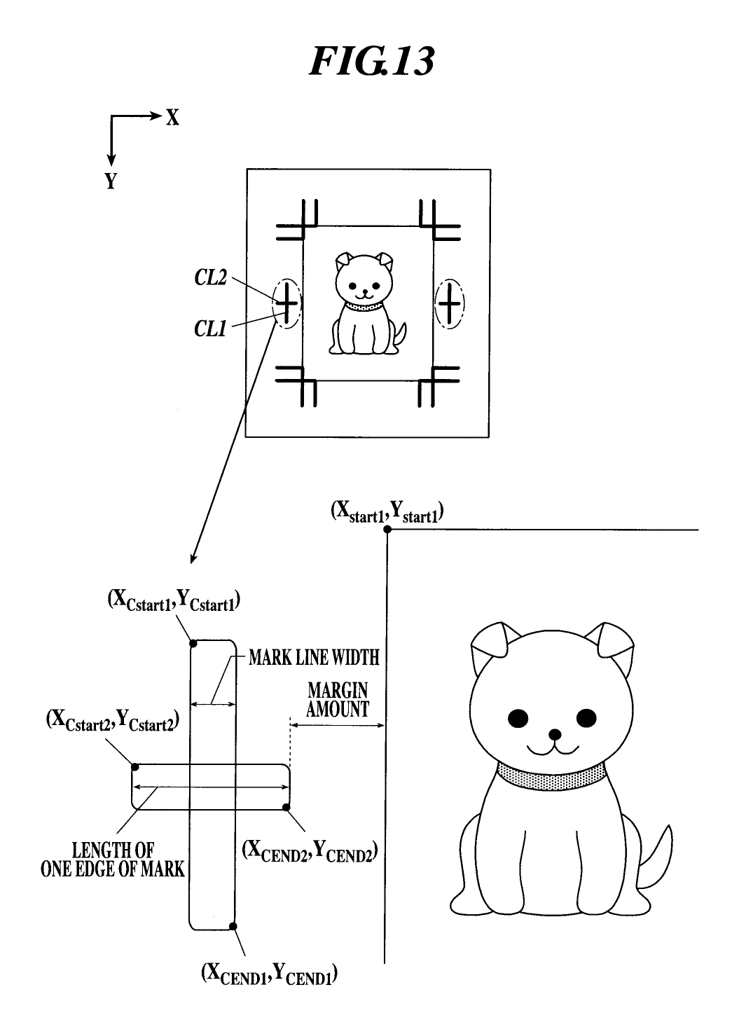

Specifically, as shown in FIG. 13, the drawing of the left side of the register mark is composed of two lines which are line CL1 surrounded in an area of (X_{cStart1}, Y_{cStart1})=(X_{Start1}−margin amount−length of one edge of mark/2−mark line width/2, Y_{Start1}+(Y_{END1}−Y_{Start1})/2−(length of one edge of mark/2)) and (X_{cEND1}, Y_{cEND1})=(X_{Start1}−margin amount−length of one edge of mark/2+mark line width/2, Y_{Start1}+(Y_{END1}−Y_{Start1})/2+(length of one edge of mark/2)) and line CL2 surrounded in an area of (X_{cStart2}, Y_{cStart2})=(X_{Start1}−margin amount−length of one edge of mark, Y_{Start1}+(Y_{END1}−Y_{Start1})/2−mark line width/2) and (X_{cEND2}, Y_{cEND2})=(X_{Start1}−margin amount, Y_{Start1}+(Y_{END1}−Y_{Start1})/2+mark line width/2). The margin amount is the margin between the register mark and the image and a value showing the margin amount is stored in advance in the nonvolatile memory 40.

Next, the drawing coordinate of the register mark of the right side is calculated (step S2113). Similar to step S2112, the calculating method in step S2113 calculates based on the coordinate S1 (X_{Start1}, Y_{Start1}), coordinate E1 (X_{END1}, Y_{END1}), margin amount, length of one edge of mark and mark line width.

When it is judged that the Y direction is longer (step S2111; Y direction long), the drawing coordinate of the upper side of the register mark is calculated (step S2114). Next, the drawing coordinate of the lower side of the register mark is calculated (step S2115). The calculating method of step S2114 and step S2115 is similar to step S2112 and step S2113.

The coordinate of the crop mark calculated in step S205 or step S207 and the coordinate of the register mark calculated in step S211 are set in a predetermined area of the mark drawing section 51b (step S22).

When it is judged that the mark output page setting is to output only on the front page (step S14; output only on front page), it is judged whether or not the image of the front page is formed (step S24). When it is judged that the image of the front page is formed (step S24; YES), the processing advances to step S16. When it is judged that the image of the front page is not formed (step S24; NO), the image output processing is performed in the printer section 60 (step S26).

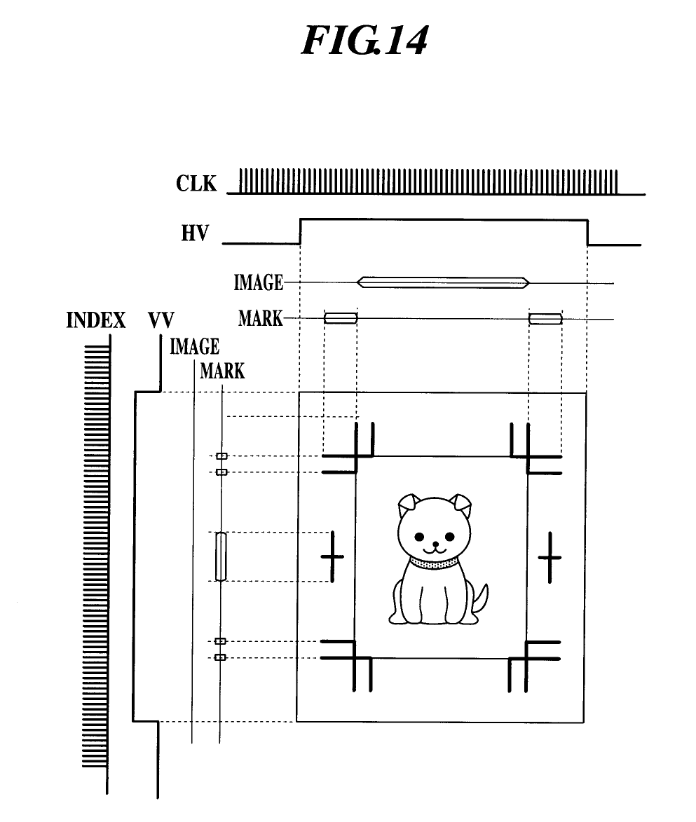

FIG. 14 is an explanatory diagram describing in detail the image output processing performed in step S26. A CLK signal generated in a unit of a pixel in the X direction of the sheet and the INDEX signal generated in a unit of a line in the Y direction of the sheet is input from the clock generation section which is not shown to the image processing section 50. An HV signal and a VV signal used in drawing the image is generated in the synchronizing signal generating section 53a based on the above signals. The counter 53b allows the main control section 51 to recognize the position to draw on the sheet. Similar processing is performed in drawing the mark. As shown in FIG. 14, the mark drawing section 51b is a register to set the position information of the mark stored in the RAM and when the counter reaches to the mark drawing position, the mark is output as image data.

It is judged whether or not output of all pages is finished (step S28). When it is judged that output of all pages is not finished (step S28; NO), the processing returns to step S10. When it is judged that output of all pages is finished (step S28; YES), the processing ends.

As described above, according to the image forming apparatus of the present embodiment, an additional image (crop mark and register mark) can be synthesized on the RIP processed image in the printer engine side to perform image forming. After the RIP processing is performed by the printer controller, even when the forming position of the added image is changed due to inserting a page, etc., the added image can be synthesized in a processing of the printer engine side, and consequently there is no need to perform the RIP processing again.

Also, the register mark synthesized in the printer engine is printed in a position showing the center of the image formed on the sheet and consequently there is no need to synthesize the register mark necessary in folding processing with the processing of the printer controller. The same can be said for the crop mark necessary in trimming.

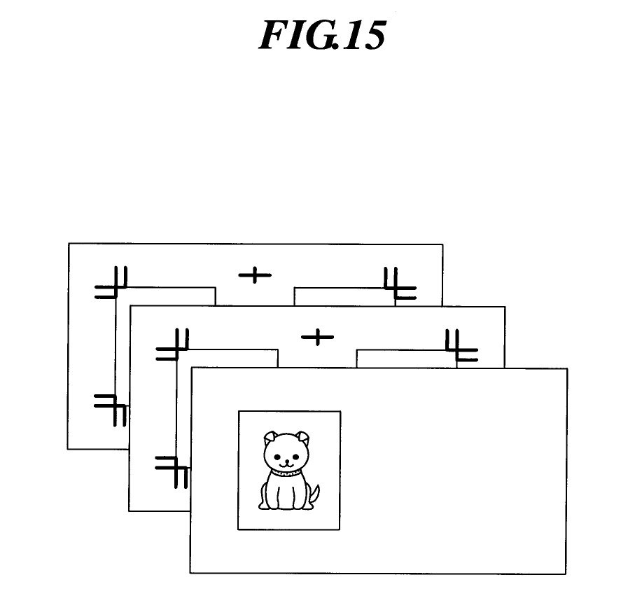

Also, the added image can be printed only on the front page or can be printed with respect to each image or each page depending on the situation. When a plurality of images are imposed, and the image printed on the last page is only one face, according to the processing in step S18, the added image is not formed on the last page as shown in FIG. 15.

The description of the above described embodiment is one example of a suitable image forming apparatus of the present invention and the present invention is not limited to the above. For example, in the mark image penetration checking processing of the present embodiment, it is judged whether or not the crop mark overlaps the image with the edge of the image as the standard. Alternatively, the margin width can be stored in advance in the nonvolatile memory 40, etc., and it can be judged whether or not the crop mark is in the area where the image and the margin width are combined. Also, in the register mark position calculation processing, the register mark is added to the long edge. Alternatively, the register mark can be added to the short edge, or can be added to both the long edge and the short edge.

Also, it is possible to allow the user to switch whether or not to add the crop mark and the register mark. When it is set not to add the crop mark, the crop mark position calculation processing can be skipped and only the register mark position calculation can be performed.

Also, as a computer readable medium other than the ROM used in the present embodiment, a nonvolatile memory such as a flash memory etc. including SD (Secure Digital) card, USB (Universal Serial Bus) memory and the like, or portable recording medium such as a CD-ROM can be applied. Also, various data such as data of the program or audio data of the present invention can be provided through a communication line superimposed on a carrier wave.

Specific operation of the image forming system can be suitably modified without leaving the scope of the present invention.

### Second Embodiment

Next, the second embodiment of the image forming apparatus is described. The second embodiment is different from the first embodiment in that there is a margin (offset) between the crop mark and the image formed on the sheet. Below, only the point different from the first embodiment is described.

The second embodiment is different from the first embodiment in that the mark information includes crop mark position offset information. The crop mark position offset information is the margin width between an edge of the image and the crop mark. For example, information showing the crop mark position offset amount is 5 mm is included n the mark information. In the mark position calculation processing in step S20, the crop mark offset information is reflected when calculating the coordinate to add the crop mark.

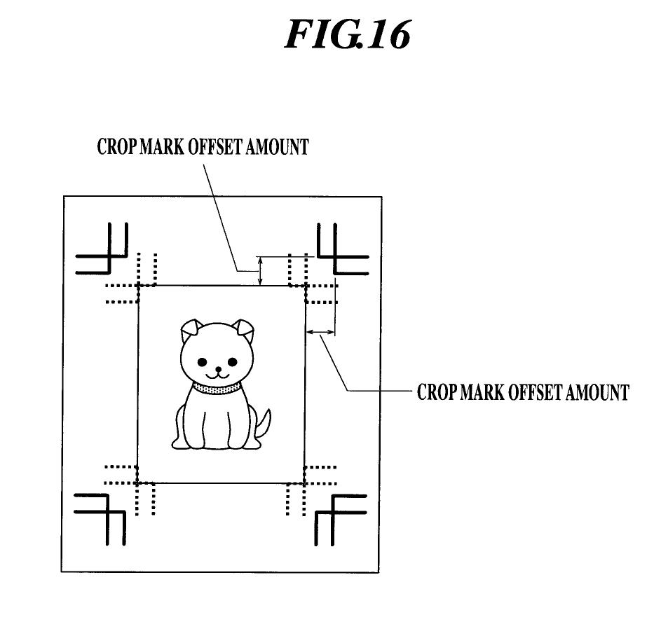

FIG. 16 shows an example of calculating the coordinate where the crop mark is to be added considering the crop mark offset information. As shown in FIG. 16, according to the image forming apparatus 1 of the second embodiment, the crop mark can be printed with a margin between the crop mark and the edge of the image where the margin (crop mark position offset amount) is formed at a predetermined distance from the edge of the image formed on the sheet.

### Third Embodiment

Next, the third embodiment of the image forming apparatus is described. The third embodiment is different from the first embodiment only on the point that the shape of the mark can be selected.

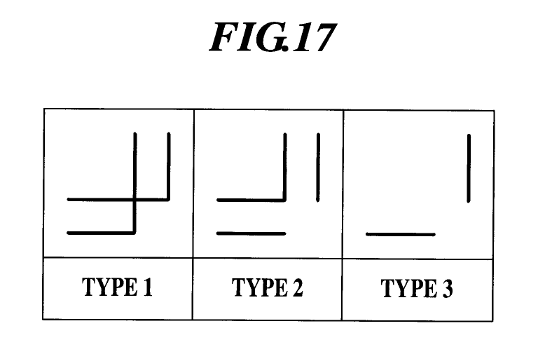

FIG. 17 shows an example of the shape of the mark which can be selected in the third embodiment. As shown in FIG. 17, according to the image forming apparatus 1 of the third embodiment, any one of type 1 to 3 can be selected by input on the operating section 80. The selected type of mark is stored in the nonvolatile memory 40, etc. In the mark drawing position calculation processing, the position is calculated similar to the first embodiment. However, the various setting values such as mark line width, etc. are different depending on the type and the various setting values are stored in the nonvolatile memory 40.

### Fourth Embodiment

Next, the fourth embodiment of the image forming apparatus is described. The fourth embodiment is different from the first embodiment only on the point that when it is set to draw the crop mark in the maximum area of the input image area or the synthesized image area, the calculation of the imposition image entire area performed in the mark position calculation processing is not performed.

Before the imposition processing in step S12 is performed, the imposition image entire area of all pages instructed to be printed is calculated. The calculation method is similar to that of step S201 and thus the description is omitted. The maximum area in all pages is to be the result of the mark drawing position calculation processing (FIG. 7), and the position is set in step S22.

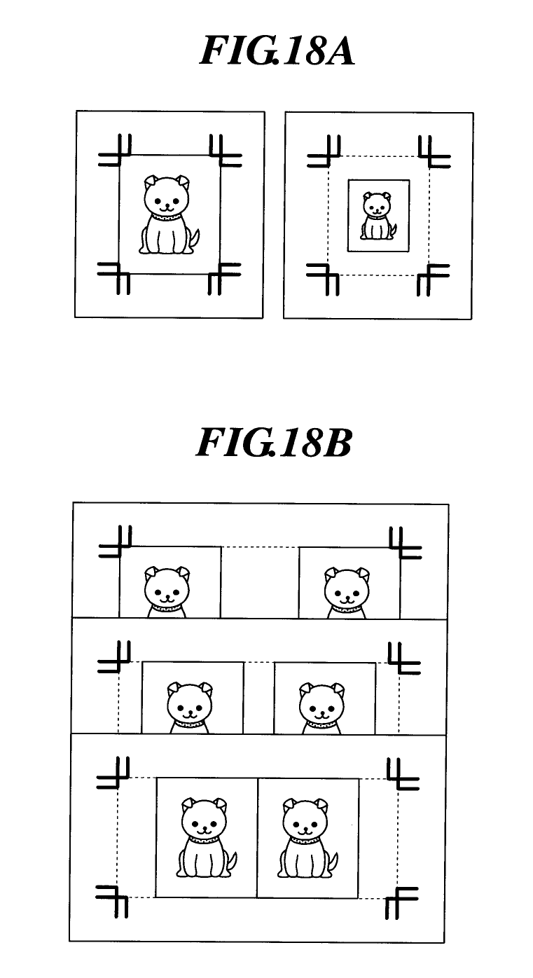

FIG. 18A shows an example of a sheet when the maximum area of all pages is the result of the mark drawing position calculation in one-in-one printing. FIG. 18B shows an example of a sheet when the maximum area of all pages is to be the result of the mark drawing position calculation in two-in-one printing. As shown in FIG. 18A and FIG. 18B, according to the image forming apparatus 1 of the fourth embodiment, the crop mark is printed in the position corresponding to the image area which is largest among the series of images formed.

### Fifth Embodiment

Next, the fifth embodiment of the image forming apparatus is described. The fifth embodiment is different from the first embodiment only in that the color of printing is changed according to the position of the crop mark.

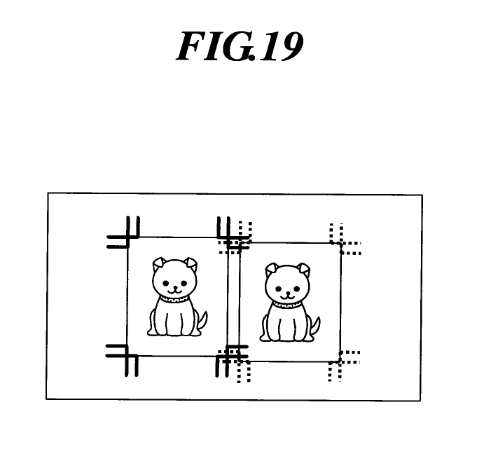

As shown in FIG. 19, the color of printing is changed according to the position of the crop mark (for example, upper left printed in red, upper right printed in blue, etc.) so that even when the crop mark overlaps, it is easy to determine which crop mark the mark is.

### Sixth Embodiment

Next, the sixth embodiment of the image forming apparatus is described. The sixth embodiment is different from the first embodiment only in that the image output operation is performed based on the image data read by the scanner section 70, mark information input from the operating section 80 and the like.

When the image is formed based on the image data obtained by reading the document in scanner 70, the image data is stored in the image memory 52a and the mark information, etc. is stored in the RAM of the main control section 51. The image output operation can be performed based on such information.

### Seventh Embodiment

Next, the seventh embodiment of the image forming apparatus is described. The seventh embodiment is different from the first embodiment only in that the front and back variation magnification processing is not performed on the RIP processed image data.

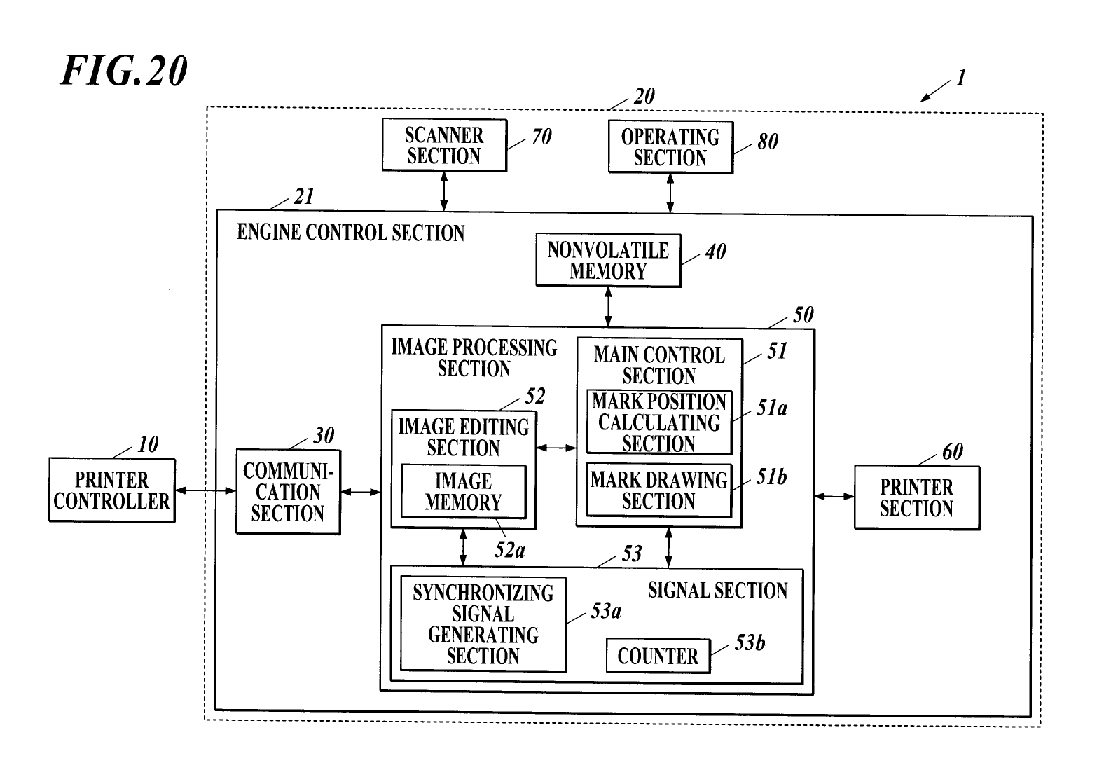

The seventh embodiment is different from the first embodiment in that the printer section 60 does not include the front and back variation magnification processing section 60a. FIG. 20 shows a block diagram of a control system of the image forming apparatus 1 of the seventh embodiment. As shown in FIG. 20, in the seventh embodiment, the printer section 60 does not include the front and back variation magnification processing section 60a.

Also, the mark position calculation processing is different from the first embodiment in the seventh embodiment. In the first embodiment, the same imposition image entire area is used in both the front and the back of the sheet, but in the seventh embodiment, the imposition image entire area is different in the front and the back.

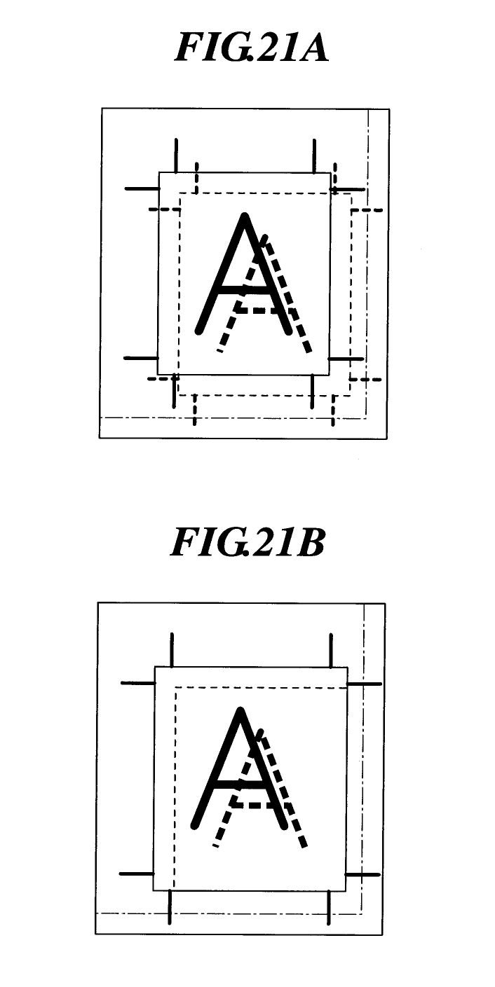

FIG. 21A shows an example of the image formed on a sheet when the magnification of the front and back is not set. The area shown in solid line is the imposition image entire area of the front and the area shown in dotted line shows the image entire area of the back. As shown in FIG. 21A, when the magnification of the front and back is not set, images with different sizes are formed on the front and back and there is a possibility that the crop mark remains when trimmed.

FIG. 21B shows an example when the mark drawing position is calculated in accordance with the maximum value of the image entire area of the front and back. In the example shown in FIG. 21B, the reference point of the variation magnification is a point at the left edge of the conveying direction of the sheet. The reduction percentage input in advance from the operating section 80 is to be 1%, and the imposition image entire area before variation magnification is a rectangular area with a diagonal line connecting coordinate O_{1S} (1027, 725) and coordinate O_{1E} (5987, 9285). When the surface is first drawn, the image of the front is smaller compared to the back, and the coordinate O_{1S} is outside of the image area of the back when reduced and correction is not performed. The coordinate O_{1E} is inside of the image area of the back when reduced and the reduction magnification is calculated and the coordinate O_{1E}=(5928+5928*0.01, 9194+9194*0.01)=(5987, 9285) and the imposition image entire area is corrected.

When the back is drawn last, the front image is smaller compared to the back image and in the above example, the coordinate O_{1S} is inside the image area of the back when reduced and the reduction magnification is calculated and the coordinate O_{1S}=(725−725*0.01, 1027−1027*0.01)=(718, 1016) and the imposition image entire area is corrected. The coordinate O_{1S} is outside the image area of the back when reduced and is not corrected.

As described above, according to the image forming apparatus 1 of the seventh embodiment, the added image can be synthesized considering the variation magnification percentage. In a typical image forming apparatus, when an image is formed on a sheet the sheet tends to shrink when the heat used in fixing subsides, and an added image can be printed corresponding to the shrunk sheet. The area shown with an alternate long and short dashed line shown in FIG. 21A and FIG. 21B is an area of the shrunk sheet. By specifying a variation magnification percentage according to the area of the sheet, the added image can be formed freely.

According to an aspect of the preferred embodiments of the present invention, there is provided an image forming apparatus to obtain image data and print information including a setting value to generate an added image synthesized to the image data and to form an image based on the obtained image data, the image forming apparatus including:
a control section to generate the added image based on the setting value included in the print information and to synthesize the generated added image with the image data to form an image.

According to another aspect of the preferred embodiments of the present invention, there is provided an image forming method of an image forming apparatus to obtain image data and print information including a setting value to generate an added image to synthesize with the image data, the method including:
controlling to generate the added image based on the setting value included in the print information, to synthesize the generated added image with the image data to perform image forming.

According to the above aspects, the mark can be printed without using the printer controller.

Preferably, in the image forming apparatus,
the print information includes image area information showing an image area of the image data; and
the control section determines a position showing a center of an area of an image formed on a sheet based on the image area information and synthesizes as the added image the added image which shows a center of an image to form the image.

Preferably, in the image forming apparatus, the control section synthesizes the added image to a position corresponding to the center of the image formed on the sheet based on the image area information to form the image.

Preferably, in the image forming apparatus, the control section performs imposition processing of the image data and synthesizes the added image to a center position of an area of an entire imposition image formed on the sheet based on the image area information to form the image.

Preferably, in the image forming apparatus, the added image synthesized by the control section is formed in a position where the sheet is folded.

Preferably, in the image forming apparatus:
the print information includes image area information to show the image area of the image data and trimming margin information to show a width of the image area when the added image is synthesized to the circumference of the image area; and
the control section performs imposition processing of the image data and synthesizes the added image to the image processed with the imposition processing based on the image area information and the trimming margin information and forms the image.

Preferably, in the image forming apparatus, the control section synthesizes the added image to four corners of each image area of image data on which imposition is to be performed to form the image.

Preferably, in the image forming apparatus, the control section synthesizes the added image to four corners of the image area corresponding to the image data after imposition to form the image.

Preferably, in the image forming apparatus, the control section determines a position to synthesize the added image based on the image area information and the trimming margin information and synthesizes the added image to four corners of the image area corresponding to each of a plurality of pieces of image data to be imposed or four corners of image area corresponding to image data after imposition.

Preferably, in the image forming apparatus, the added image synthesized by the control section is a crop mark showing a position to trim the sheet on which the image is formed.

Preferably, in the image forming apparatus:
the print information further includes specification information to specify a position on which the added image is formed; and
the control section synthesizes a plurality of added images based on the specification information including a margin around the image area to form the image.

Preferably, in the image forming apparatus, the control section does not synthesize the added image when the image to be formed on the sheet is one in performing the imposition processing of a plurality of pieces of image data.

Preferably, in the image forming apparatus, when a series of images are formed on a plurality of sheets, the control section synthesizes the added image to four corners of the image area of the sheet where the image area of the sheet is maximum to form the image.

Preferably, in the image forming apparatus, when imposition processing of the image data is performed and a series of images are formed on a plurality of sheets, the control section synthesizes the added image to four corners of the image area of the sheet where the image area of the sheet after imposition is maximum to form the image.

Preferably, in the image forming apparatus, the control section synthesizes the added image only to the first sheet among a plurality of sheets on which the image is formed to form the image.

Preferably, in the image forming apparatus, the control section does not synthesize the added image in the image area when the added image to be formed on the sheet is included in the image area in performing the imposition processing of the image data.

Preferably, the image forming apparatus further includes a counter to generate a signal at a predetermined cycle,
wherein the control section creates the added image composed of the linear data based on the signal generated by the counter to synthesize the image data.

Preferably, in the image forming apparatus, the control section synthesizes the added image with a different color with respect to each of the added image when a plurality of added images are synthesized.

Consequently, the color used in printing is changed according to the position of the crop mark (for example, red is used for upper left, blue is used for upper right, etc.) and therefore, it is easy to judge which crop mark even when the crop marks overlap.

Preferably, the image forming apparatus further includes an operating section to input variation magnification percentage of front and back of the image to be formed on the sheet,
wherein the position where the added image is formed is calculated based on the variation magnification percentage input on the operating section.

Consequently, the added image can be synthesized considering the variation magnification percentage.

Although various exemplary embodiments have been shown and described, the invention is not limited to the embodiments shown. Therefore, the scope of the invention is intended to be limited solely by the scope of the claims that follow and not by the above explanation, and it is intended that the present invention covers modifications and variations that come within the scope of the appended claims and their equivalents.

The present U.S. Patent Application claims priority under the Paris Convention of Japanese Patent Application No. 2009-155166 filed on Jun. 30, 2009 to the Japanese Patent Office, which shall be a basis for correcting mistranslations.

What is claimed is:

1. An image forming apparatus to obtain image data and print information including a setting value to generate an added image synthesized to the image data and to form an image based on the obtained image data, the image forming apparatus comprising:
a control section to generate the added image based on the setting value included in the print information and to synthesize the generated added image with the image data to form an image.

2. The image forming apparatus of claim 1, wherein:
the print information includes image area information showing an image area of the image data; and
the control section determines a position showing a center of an area of an image formed on a sheet based on the image area information and synthesizes as the added image the added image which shows a center of an image to form the image.

3. The image forming apparatus of claim 2, wherein the control section synthesizes the added image to a position corresponding to the center of the image formed on the sheet based on the image area information to form the image.

4. The image forming apparatus of claim 2, wherein the control section performs imposition processing of the image data and synthesizes the added image to a center position of an area of an entire imposition image formed on the sheet based on the image area information to form the image.

5. The image forming apparatus of claim 2, wherein the added image synthesized by the control section is formed in a position where the sheet is folded.

6. The image forming apparatus of claim 1, wherein:
the print information includes image area information to show the image area of the image data and trimming margin information to show a width of the image area when the added image is synthesized to the circumference of the image area; and
the control section performs imposition processing of the image data and synthesizes the added image to the image processed with the imposition processing based on the image area information and the trimming margin information and forms the image.

7. The image forming apparatus of claim 6, wherein the control section synthesizes the added image to four corners of each image area of image data on which imposition is to be performed to form the image.

8. The image forming apparatus of claim 6, wherein the control section synthesizes the added image to four corners of the image area corresponding to the image data after imposition to form the image.

9. The image forming apparatus of claim 6, wherein the control section determines a position to synthesize the added image based on the image area information and the trimming margin information and synthesizes the added image to four corners of the image area corresponding to each of a plurality of pieces of image data to be imposed or four corners of image area corresponding to image data after imposition.

10. The image forming apparatus of claim 6, wherein the added image synthesized by the control section is a crop mark showing a position to trim the sheet on which the image is formed.

11. The image forming apparatus of claim 6, wherein:
the print information further includes specification information to specify a position on which the added image is formed; and
the control section synthesizes a plurality of added images based on the specification information including a margin around the image area to form the image.

12. The image forming apparatus of claim 1, wherein the control section does not synthesize the added image when the image to be formed on the sheet is one in performing the imposition processing of a plurality of pieces of image data.

13. The image forming apparatus of claim 6, wherein when a series of images are formed on a plurality of sheets, the control section synthesizes the added image to four corners of the image area of the sheet where the image area of the sheet is maximum to form the image.

14. The image forming apparatus of claim 6, wherein when imposition processing of the image data is performed and a series of images are formed on a plurality of sheets, the control section synthesizes the added image to four corners of the image area of the sheet where the image area of the sheet after imposition is maximum to form the image.

15. The image forming apparatus of claim 13, wherein the control section synthesizes the added image only to the first sheet among a plurality of sheets on which the image is formed to form the image.

16. The image forming apparatus of claim 6, wherein the control section does not synthesize the added image in the image area when the added image to be formed on the sheet is included in the image area in performing the imposition processing of the image data.

17. The image forming apparatus of claim 1, further comprising a counter to generate a signal at a predetermined cycle,
wherein the control section creates the added image composed of the linear data based on the signal generated by the counter to synthesize the image data.

18. The image forming apparatus of claim 1, wherein the control section synthesizes the added image with a different color with respect to each of the added image when a plurality of added images are synthesized.

19. The image forming apparatus of claim 1, further comprising an operating section to input variation magnification percentage of front and back of the image to be formed on the sheet,
wherein the position where the added image is formed is calculated based on the variation magnification percentage input on the operating section.

20. An image forming method of an image forming apparatus to obtain image data and print information including a setting value to generate an added image to synthesize with the image data, the method comprising:
controlling to generate the added image based on the setting value included in the print information, to synthesize the generated added image with the image data to perform image forming.
